(19) United States
(12) Patent Application Publication
(10) Pub. No.: US 2013/0004793 A1
(43) Pub. Date: Jan. 3, 2013

(54) COPPER ALLOY FOR ELECTRONIC MATERIAL AND METHOD OF MANUFACTURE FOR SAME

(76) Inventor: Hiroshi Kuwagaki, Ibaraki (JP)

(21) Appl. No.: 13/636,287

(22) PCT Filed: Mar. 23, 2011
(86) PCT No.: PCT/JP2011/057026

§ 371 Date: Sep. 20, 2012

(51) Int. Cl. C22C 45/00; B32B 15/01; B24B 1/00

(52) U.S. Cl. 428/675; 148/403; 451/57

(57) ABSTRACT

There is provided a copper alloy for electronic material which exhibits excellent plating uniformity. A copper alloy for electronic material, wherein, when its cross section parallel to a rolling direction is observed by SIM, an area ratio of amorphous structure and crystal grains having a grain size of less than 0.1 μm at a depth range of 0.5 μm or less from the surface is 1% or less, and a ratio of the number of crystal grains having a grain size of at least 0.1 μm and less than 0.2 μm to the overall number of crystal grains having a grain size of at least 0.1 μm at a depth range of 0.2-0.5 μm from the surface is 47.5% or more.

### TECHNICAL FIELD

The present invention relates to copper alloy suitable as an electronic material which is required to have excellent platability, and to method of manufacture for the same.

### BACKGROUND ART

Copper alloys used in electronics are subjected to plating for functional use, which utilizes physical properties of plating film itself such as electric property and magnetic property. They are also subjected to plating for bonding use for wire bonding or implementation of printed board. For example, as for a conductive spring material such as a terminal, connector, switch, relay and the like, Ni plating, Cu plating or Sn plating and the like is given for the purpose of improving contact resistance, solderability, mating and demating property and the like, and as for a lead frame, Ag plating or Cu plating for wire bonding, or solder plating for implementation of board and the like is given.

In several kinds of copper alloy such as Corson alloy, phosphor bronze and the like, plating film is sometimes formed ununiformly when the plating has been given onto the surface (FIG. 2). When the surface of such plating film is observed with a high-powered microscope, island shaped hollows (hereafter, referred to as “island shaped plating”) are found in the places where the plating film is thin (FIG. 3). Ununiform plating causes an appearance problem as well as the problem that various functions provided by the plating film cannot be exerted sufficiently.

By the way, the surface layer of copper alloys produced by, after casting, an appropriate combination of heat treatment, hot rolling, cold rolling and buffing includes a so called “damaged layer” that is different from the inside. The damaged layer is composed of the outermost “Beilby layer” which has an amorphous structure and the “fine crystal layer” which is present inside of Beilby layer. The size of crystal grains becomes larger as they go inside. Consequently, crystal grains come to have the same size as those in the matrix phase.

Up to now, as the damaged layer has been known to have a bad influence on the platability, it is commonly practiced to remove the damaged layer in advance before plating.

For example, Japanese Patent Application Publication No. H11-29894 (Patent document 1) discloses that nickel plating should be performed after removing the damaged layer (30-40 μm of thickness) in the surface by an electrolytic etching using aqueous alkaline solutions such as an aqueous solution of caustic soda since the damaged layer inhibits adhesion between the plating film and the base material.

Japanese Patent Application Publication No. 2006-2233 (Patent document 2) discloses that the damaged layer is removed for the purpose of providing a plated product exhibiting excellent forming workability as its surface is not cracked by bending and the like. As methods for removing the damaged layer, a dissolution method using acid such as sulfuric acid, nitric acid, hydrochloric acid, hydrogen peroxide solution, hydrofluoric acid and the like, an electric dissolution method in an electrolyte, a sputtering method, an etching method and the like are mentioned.

Japanese Patent Application Publication No. 2007-39804 (Patent document 3) describes a copper alloy for electronic components in which a thickness of the damaged layer (amorphous structure or crystal structure with a grain size of 0.2 μm or less) in the surface layer is controlled to be 0.2 μm or less for the purpose of providing a copper alloy for electronic components exhibiting excellent platability with no abnormal deposition of plating and no decrease of oxidized film adhesion. According to this document, the thickness of the damaged layer is an average of measured values at five places for observation, said values being measured at the positions where the damaged layer is the thickest in each visual field of expanded observation. It is described that the damaged layer is removed by chemical dissolving treatment, electrochemical dissolving treatment, and physical treatment such as sputtering. It is described, in the working example, that the damaged layer was removed by immersion into a mixed acid of sulfuric acid and hydrogen peroxide solution, heat treatment in the heating furnace under hydrogen reduction atmosphere and electrolytic dissolution in an aqueous solution containing phosphoric acid.

### PRIOR ART DOCUMENTS

Patent document 1, Japanese Patent Application Publication No. H11-29894
Patent document 2, Japanese Patent Application Publication No. 2006-2233
Patent document 3, Japanese Patent Application Publication No. 2007-39804

### SUMMARY OF INVENTION

### Problem to be Solved by the Invention

The prior art documents describes removal of the damaged layer for the purpose of adhesion between plating film and base material as well as restriction of abnormal deposition of plating. However, there is sill room for improvement with regard to uniformity of the plating film. Therefore, an object of the present invention is to provide a copper alloy for electronic material exhibiting excellent plating uniformity. Further, another object of the present invention is to provide a method of manufacture for such a copper alloy for electronic material.

### Means for Solving Problem

The present inventor studied eagerly in order to solve the problem and found that, rather than completely removing the damaged layer, improvement of plating film uniformity progresses when only Beilby layer is removed from the damaged layer and fine crystal layer is allowed to remain with a certain thickness. Specifically, it has been found that crystal grains having a grain size of at least 0.1 μm and less than 0.2 μm contribute to improvement of uniformity of the plating film and it is thus important to leave the layer containing crystal grains of this grain size range at a certain ratio or more with a certain thickness.

The present invention was completed on the basis of said finding. In one aspect, the present invention provides a copper alloy for electronic material, wherein, when its cross section parallel to a rolling direction is observed by SIM, an area ratio of amorphous structure and crystal grains having a grain size of less than 0.1 μm at a depth range of 0.5 μm or less from the surface is 1% or less, and a ratio of the number of crystal grains having a grain size of at least 0.1 μm and less than 0.2 μm to the overall number of crystal grains having a grain size of at least 0.1 μm at a depth range of 0.2-0.5 μm from the surface is 47.5% or more.

In one embodiment of the copper alloy for electronic material related to the present invention, when its cross section parallel to a rolling direction is observed by SIM, a ratio of the number of crystal grains having a grain size of at least 0.1 μm and less than 0.2 μm to the overall number of crystal grains having a grain size of at least 0.1 μm at a depth range of less than 0.2 μm from the surface is 57.5% or more.

In another embodiment of the copper alloy for electronic material related to the present invention, the copper alloy is phosphor bronze, titanium copper or Corson alloy.

In another aspect, the present invention provides a method of manufacture for a copper alloy for electronic material, comprising:

Step 1) polishing a surface of copper alloy base material with an abrasive of count #600-8000 to form a damaged layer having a sufficient thickness such that, when its cross section parallel to a rolling direction is observed by SIM after Step 2), a ratio of the number of crystal grains having a grain size of at least 0.1 μm and less than 0.2 μm to the overall number of crystal grains having a grain size of at least 0.1 μm at a depth range of 0.2-0.5 μm from the surface becomes 47.5% or more, and then Step 2) further polishing with an abrasive having a particle size (d50) of 0.01-0.5 μm to remove amorphous structure and fine crystal grains having a grain size of less than 0.1 μm from the damaged layer such that, when its cross section parallel to a rolling direction is observed by SIM, an area ratio of amorphous structure and crystal grains having a grain size of less than 0.1 μm at a depth range of 0.5 μm or less from the surface is 1% or less, and a ratio of the number of crystal grains having a grain size of at least 0.1 μm and less than 0.2 μm to the overall number of crystal grains having a grain size of at least 0.1 μm at a depth range of 0.2-0.5 μm from the surface is 47.5% or more.

In one embodiment of the method of manufacture for a copper alloy for electronic material related to the present invention, the abrasive used in Step 1 is made of silicon carbide, and the abrasive used in Step 2 is made of aluminum oxide or colloidal silica.

In one embodiment of the method of manufacture for a copper alloy for electronic material related to the present invention, the polishing in Step 1 and Step 2 are performed by buffing.

In yet another aspect, the present invention provides a plated product provided with a plating film on a surface of the copper alloy related to the present invention.

In one embodiment of the plated product related to the present invention, the plating film contains any one or more of Ni, Sn and Ag.

### Effect of the Invention

According to the present invention, uniformity of the plating film formed on the surface of copper alloy will improve and island shaped plating will decrease.

### BRIEF DESCRIPTION OF DRAWINGS

FIG. 1 shows an example of SEM photograph of uniform plating film provided on the surface of a copper alloy related to the present invention.

FIG. 2 shows an example of SEM photograph of ununiform plating film provided on the surface of a copper alloy.

FIG. 3 shows a SEM photograph of an expanded part of island shaped plating in FIG. 1.

FIG. 4 shows a schematic depiction of cross section of a copper alloy related to the present invention (source: “Handbook of metal surface technology”, Edited by The Surface Finishing Society of Japan, Revised new edition).

### MODES FOR CARRYING OUT THE INVENTION

### 1. Composition of Copper Alloy

The present invention can be applied to copper alloys with various compositions and there is no particular limitation. However, the present invention can be preferably applied to phosphor bronze, Corson alloy, brass, German silver and titanium copper which are likely to cause the problem of island shaped plating.

In the present invention, phosphor bronze means a copper alloy containing copper as a principal ingredient, Sn and smaller amount of P. By way of example, phosphor bronze has a composition composed of 3.5-11 mass % of Sn, 0.03-0.35 mass % of P, the balance being copper and unavoidable impurities.

In the present invention, Corson alloy means a copper alloy which contains an added element which forms a compound with Si (for example, any one or more of Ni, Co and Cr) and deposits as a secondary phase particle in the matrix phase. By way of example, Corson alloy has a composition composed of 1.0-4.0 mass % of Ni, 0.2-1.3 mass % of Si, the balance being copper and unavoidable impurities. As another example, Corson alloy has a composition composed of 1.0-4.0 mass % of Ni, 0.2-1.3 mass % of Si, 0.03-0.5 mass % of Cr, the balance being copper and unavoidable impurities. As yet another example, Corson alloy contains 1.0-4.0 mass % of Ni, 0.2-1.3 mass % of Si, 0.5-2.5 mass % of Co, the balance being copper and unavoidable impurities. As yet another example, Corson alloy contains 1.0-4.0 mass % of Ni, 0.2-1.3 mass % of Si, 0.5-2.5 mass % of Co, 0.03-0.5 mass % of Cr, the balance being copper and unavoidable impurities. As yet another example, Corson alloy contains 0.2-1.3 mass % of Si, 0.5-2.5 mass % of Co, the balance being copper and unavoidable impurities.

To Corson alloy, other element(s) (e.g., Mg, Sn, B, Ti, Mn, Ag, P, Zn, As, Sb, Be, Zr, Al and Fe) can be optionally added. In general, these other element(s) is (are) added up to about 2.0 mass % in total. For example, as yet another example, Corson alloy contains 1.0-4.0 mass % of Ni, 0.2-1.3 mass % of Si, 0.01-2.0 mass % of Sn, 0.01-2.0 mass % of Zn, the balance being copper and unavoidable impurities.

In the present invention, brass means an alloy of copper and zinc, especially a copper alloy containing 20 mass % or more of zinc.

In the present invention, German silver means a copper alloy containing 60-75 mass % of copper as a principal ingredient, 8.5-19.5 mass % of nickel, and 10-30 mass % of zinc.

In the present invention, titanium copper means a copper alloy containing copper as a principal ingredient and 1.0-4.0 mass % of Ti. By way of example, a titanium copper contains 1.0-4.0 mass % of Ti, the balance being copper and unavoidable impurities. As another example, a titanium copper contains 1.0-4.0 mass % of Ti, 0.01-1.0 mass % of Fe, the balance being copper and unavoidable impurities.

### 2. Cross-Sectional Structure

When a cross section of the copper alloy related to the present invention is observed by SIM in a direction parallel to the rolling direction, it has a following characteristic structure.

First of all, amorphous structure and fine crystal grains having a grain size of less than 0.1 μm should be removed because these structures cause “island shaped plating” and thus have a bad influence on the uniformity of the plating film.

Specifically, at a depth range of 0.5 μm or less from the surface, an area ratio of amorphous structure and crystal grains having a grain size of less than 0.1 μm at a depth range of 0.5 μm or less from the surface is 1% or less, preferably 0.5% or less, more preferably 0%. The reason why the depth of 5 μm or less from the surface is defined is that the deeper portion has little effect on the uniformity of the plating film. The area ratio is measured by the following method. Specifically, a measuring area of 0.5 μm in depth direction from the surface and 15 μm in the width direction is set, and then crystal grains having a grain size of 0.1 μm or more is marked. The marked crystal grains and other structures (i.e., amorphous structure and crystal grains having a grain size of less than 0.1 μm) are distinguished by binarizing with image processing. Thus, the area ratio occupied by amorphous structure and the crystal grains having a grain size of less than 0.1 μm with respect to the entire measuring area in the field of vision is calculated. An average for 5 fields of vision is employed as the measured value.

On the other hand, crystal grains having a grain size of 0.1 μm or more and less than 0.2 μm should be positively left because they contribute to the increase of the uniformity of the plating film. According to the prior art knowledge, it has been said that the grain size within this range belongs to the crystal grains which constitute fine crystal layer and it is therefore desirable to remove them. However, according to the study by the present inventor, it is rather desirable to positively form them in order to increase the uniformity of the plating film. Further, in case where the crystal grains of this size are removed, residual grains are the crystal grains having larger size. Such large crystal grains do not contribute to the uniformity of the plating film.

Thus, in one embodiment of the copper alloy related to the present invention, at a depth range of 0.2-0.5 μm from the surface, a ratio of the number of crystal grains having a grain size of at least 0.1 μm and less than 0.2 μm to the overall number of crystal grains having a grain size of at least 0.1 μm is 50% or more. This number ratio is preferably higher, e.g., it can be 50-90%. However, as the ratio of crystal grains belonging to this grain size range is increased, the ratio of amorphous structure and fine crystal grains having a grain size of less than 0.1 μm is also gradually increased, impairing the effect of increasing the uniformity of plating film. Accordingly, a preferable number ratio of is 80% or less, and is more preferably 70% or less.

In another embodiment of a copper alloy related to the present invention, at a depth range of less than 0.2 μm from the surface, a ratio of the number of crystal grains having a grain size of at least 0.1 μm and less than 0.2 μm to the overall number of crystal grains having a grain size of at least 0.1 μm is 60% or more. The number ratio is preferably higher, e.g., it can be 60-90%. However, due to the same reason as described above, as the ratio gets higher, the effect of increasing the uniformity of the plating film is impaired. Therefore, the number ratio is preferably 90% or less, more preferably 80% or less.

In the present invention, the ratio of the number of crystal grains having a grain size of at least 0.1 μm and less than 0.2 μm to the overall number of crystal grains having a grain size of at least 0.1 μm is measured in each range of depth according to the following procedure. At first, the cross section of a copper alloy to be measured is cut with FIB in a direction parallel to the rolling direction so that a cross section is exposed. After that, the cross section is observed by SIM at a magnification of 8000-15000 times. Subsequently, each grain size of all the crystal grains existing in the field of vision is determined in each of the depth range of less than 0.2 μm from the surface and the depth range of 0.2-0.5 μm from the surface. The ratio of the number of crystal grains having a grain size of at least 0.1 μm and less than 0.2 μm to the overall number of crystal grains having a grain size of at least 0.1 μm is then calculated. This is performed for 5 fields of vision in total. A grain which intersects the boundary of the field of vision and can be only partially seen is not counted. The average of 5 fields of vision is employed as the measured value.

In the present invention, each grain size of crystal grain is defined as an average of the longest line segment in the depth direction which can traverse within the crystal and the longest line segment in the direction perpendicular to the depth direction.

Further, in the present invention, the number ratio is indicated in units of 5% by rounding off the measured value. For example, when the measured value is 47.5% or more and less than 52.5%, the ratio is indicated as 50%. Therefore, when the lower limit is set as 50%, any case where the measured value is 48.2%, 50.0% or 51.2% is included in the scope of the present invention.

### 3. Method of Manufacture

The copper alloy related to the present invention can be manufactured by producing copper alloy base material having a desired composition by, after casting, combining the conventional means such as heat treatment, hot rolling and cold rolling and then performing a certain surface treatment.

Before the surface treatment, it is preferable to perform degreasing and pickling for cleaning in order to remove grease stains adhered to the surface of the base material. As the method for degreasing, while there is no particular limitation, alkaline degreasing, solvent degreasing, and electrolytic degreasing may be mentioned. As for the method for pickling, while there is no particular limitation, a method in which the base material is immersed in a pickling bath containing sulfuric acid for a certain period of time.

The surface treatment includes Step 1) polishing a surface of copper alloy base material with an abrasive of count #600-8000 and then Step 2) further polishing with an abrasive having a particle size of 0.01-0.2 μm.

Step 1 aims to form a damaged layer. Though the damaged layer can be formed somewhat in the conventional process for producing a copper alloy, it is desirable to form the damaged layer with a sufficient thickness through Step 1, for providing the crystal grains having a grain size of at least 0.1 μm and less than 0.2 μm in the sufficient depth range. An effective abrasive for forming a damaged layer is of count #600-#8000, preferably #1200-#4000, and more preferably #1500-#3000 as prescribed in JIS6001 (1998). The material of abrasive used in Step 1 includes, but not limited to, silicon carbide, aluminum oxide, diamond and the like. There is no particular limitation for the material provided that it is of said count range.

The object of Step 2 is to remove the outermost Beilby layer (corresponding to amorphous structure and fine crystal grain having a grain size of less than 0.1 μm in the present invention) from the damaged layer prepared in Step 1. An effective particle size of the abrasive for selectively removing Beilby layer from the damaged layer is in the range of 0.01-0.5 μm, preferably 0.05-0.4 μm, more preferably 0.1-0.3 μm in terms of d50 measured by a laser diffraction scattering method. When the particle size is greater than 0.1 μm, crystal grains having a grain size of at least 0.1 μm and less than 0.2 μm are also easily removed. As for the material of abrasive used in Step 2, while there is no particular limitation, aluminum oxide and colloidal silica are preferable because they have a small grain size.

The polishing in Step 1 and Step 2 is preferably performed by buffing. In the present invention, buffing means polishing with an abrasive cloth impregnated with an abrasive in the form of paste or suspension (slurry). It does not matter whether buff is rotated or not. However, in order to obtain uniform distribution of crystal grains having a grain size of at least 0.1 μm and less than 0.2 μm, it is desirable to rotate the buff at a high speed and to push it against the copper alloy base material under a constant pressure.

Acid pickling may be performed between Step 1 and Step 2 in order that only Beilby layer may be easily removed during the second polishing. However, for acid pickling at this stage, it is desirable to use sulfuric acid, preferably sulfuric acid of conc. 10-200 g/L, because when a mixed acid of sulfuric acid and hydrogen peroxide is used, crystal grains having a grain size of at least 0.1 μm and less than 0.2 μm are also easily removed.

### 4. Kinds of Plating

Various plating can be provided on the copper alloy related to the present invention and there is no particular limitation for the kinds of plating. For example, Ni, Sn, As plating and the like may be provided. Above all, the present invention can be preferably applied to Ni plating since Ni plating tends to easily form the island shaped plating. Therefore, in one embodiment of the present invention, a plating film contains any one or more of Ni, Sn and Ag.

As for the method for plating, while there is any particular restriction, for example it can be obtained by a wet process plating such as electroplating and electroless plating, or dry plating such as CVD and PVD. From the point of view of productivity and cost, electroplating is preferable.

### 5. Use Application

Copper alloys related to the present invention can be provided as various wrought copper products such as plate, strip, tube, bar and wire and can be preferably used for electronic components such as lead frame, connector, pin, terminal, relay, switch, foil material for a secondary battery.

### Example

Working examples according to the present invention are shown below together with comparative examples. They are given for better understanding of the present invention and advantages thereof, and not intended to restrict the scope of the present invention.

Each copper alloy having a composition indicated in Table 1 was cast. Heat treatment, hot rolling and cold rolling were then repeated appropriately to obtain each copper alloy plate with a thickness of 0.1 mm. Each copper alloy plate was degreased by alkaline degreasing, acid pickled by immersing it in an acid bath containing 100 g/L of sulfuric acid, and then subjected to the surface treatment according to the procedure described in Table 1. In Table 1, silicon carbide was used as an abrasive for “Buffing (1)”. In “Acid Pickling”, “Sulfuric acid” indicates a process in which a test plate is immersed in 100 g/L sulfuric acid for 10 seconds, and “Mixed acid” indicates a process in which a test plate is immersed in an aqueous solution containing 100 g/L sulfuric acid and 10 g/L hydrogen peroxide for 10 seconds. In “#3000” of “Buffing (2)”, silicon carbide was used as an abrasive. The particle size (d50) of the abrasive used in Buffing (2) was determined by using a laser diffraction particle size analyzer SALD-2100 (Shimazu Corporation).

With regard to the copper alloy plate after the surface treatment, the followings were measured by using the methods mentioned before:

A) The area ratio of amorphous structure and crystal grains having a grain size of less than 0.1 μm at a depth range of 0.5 μm or less from the surface,
B) The ratio of the number of crystal grains having a grain size of at least 0.1 μm and less than 0.2 μm to the overall number of crystal grains having a grain size of at least 0.1 μm at a depth range of 0.2-0.5 μm from the surface,
C) The ratio of the number of crystal grains having a grain size of at least 0.1 μm and less than 0.2 μm to the overall number of crystal grains having a grain size of at least 0.1 μm at a depth range of less than 0.2 μm from the surface.

With regard to the values B and C in Table, each measured value was rounded off and the value in units of 5% is described. For example, when the measured value is at least 62.5% and less than 67.5%, Table describes 65%.

Subsequently, Ni plating was performed under the following condition:

### Condition for Ni Plating

Bath composition: NiSO₄-6H₂O 280 g/L

Plating condition: current density: 5 A/dm²
plating time: 15 sec

Subsequently, a photograph was taken for each plated surface with an optical microscope (magnification: ×100, visual field area: 0.15 mm²) to measure the area ratio of island shaped plating. The evaluation standard was as shown below.

S: No island shaped plating

A: The area ratio of island shaped plating is not more than 10%

B: The area ratio of island shaped plating is more than 10% and not more than 20%

C: The area ratio of island shaped plating is more than 20% and not more than 50%

D: The area ratio of island shaped plating is more than 50%

Normal portions and island shaped plating portions are binarized by an image analyzer to calculate the area ratio of island shaped plating.

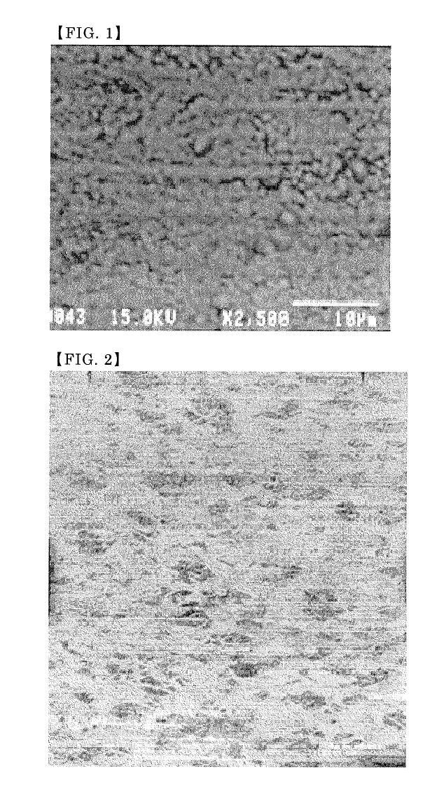

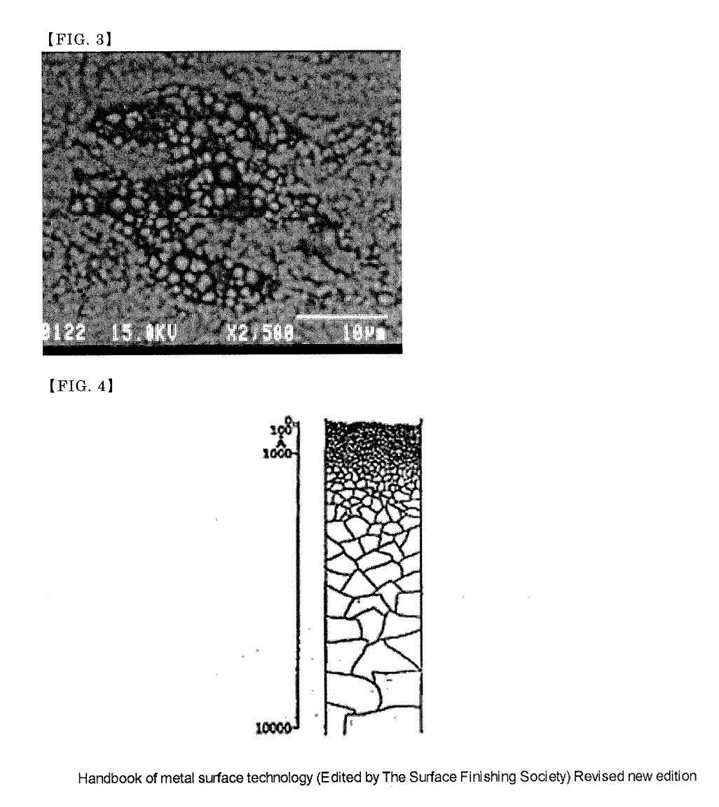

The results were shown in Table 1. FIG. 1 is a SEM photograph of the plating surface of No. 14.

It can be seen, from Table 1, that copper alloys No. 1-27 according to the present invention had decreased island shaped plating, and are superior in even plating.

On the other hand, in Comparative examples No. 28, 33, 35, 37, 39, 41, 43, 45, 47, 49, 51 and 53, as buffing was not carried out, a damaged layer itself was not formed. Therefore, superior plating property was not obtained.

In Comparative example No. 29, 34, 36, 38, 40, 42, 44, 46, 48, 50, 52 and 54, while a damaged layer was formed since buffing was performed, the layer was not removed and therefore Beilby layer was remained. As a result, a superior plating property was not obtained.

In Comparative example No. 30, the damaged layer formed by the first buffing was removed by a strong acid pickling, and therefore, not only Beilby layer, but also crystal grains having a grain size of at least 0.1 μm and less than 0.2 μm were excessively removed. As a result, the plating property was inferior to the Examples of the present invention.

In Comparative example No. 31, the damaged layer formed by the first buffing was removed by a strong acid pickling, and further the second buffing was performed, and therefore, not only Beilby layer, but also crystal grains having a grain size of at least 0.1 μm and less than 0.2 μm were completely removed. As a result, the plating property was inferior to the Examples of the present invention.

In Comparative example No. 32, the damaged layer formed by the first buffing was removed by a strong acid pickling, and then buffing was performed in the similar way as the first Buffing. As a result, the properties similar to Comparative example No. 29 was obtained.

TABLE 1

| | Composition (mass %) | | | | | | | | | | | Acid | Buffing(2) | A | B | C | Plat- |
|---|---|---|---|---|---|---|---|---|---|---|---|---|---|---|---|---|---|
| No | Ni | Si | Co | Cr | Sn | Zn | P | Ti | Others | Cu | Buffing(1) | Pickling | (grain size) | (%) | (%) | (%) | ability |
| 1 | 2.5 | 0.56 | | | | | | | | balance | #3000 | omitted | Aluminum oxide (0.3 μm) | 0 | 50 | 60 | S |
| 2 | 2.5 | 0.56 | | | | | | | | balance | #3000 | omitted | Colloidal silica (0.05 μm) | 0.5 | 65 | 75 | A |
| 3 | 2.5 | 0.56 | — | — | | | | | | balance | #3000 | omitted | Aluminum oxide (0.05 μm) | 0.4 | 70 | 80 | A |
| 4 | 2.5 | 0.56 | | | | | | | | balance | #3000 | omitted | Colloidal silica (0.02 μm) | 1 | 80 | 90 | B |
| 5 | 2.5 | 0.56 | — | — | | | | | | balance | #3000 | Sulfuric | Colloidal silica (0.05 μm) | 0.3 | 70 | 80 | A |
| | | | | | | | | | | | | acid | | | | | |
| 6 | 2.5 | 0.56 | — | 0.2 | | | | | | balance | #3000 | omitted | Aluminum oxide (0.3 μm) | 0 | 55 | 65 | S |
| 7 | 2.5 | 0.56 | — | 0.2 | | | | | | balance | #3000 | omitted | Colloidal silica (0.05 μm) | 0.5 | 70 | 80 | A |
| 8 | 2.5 | 0.56 | — | | | | | | 0.1Mg | balance | #3000 | omitted | Colloidal silica (0.02 μm) | 1 | 80 | 90 | B |
| 9 | 2.5 | 0.56 | — | | | | | | 0.1Mg | balance | #3000 | omitted | Colloidal silica (0.05 μm) | 0.5 | 70 | 80 | A |
| 10 | 2.5 | 0.56 | — | | | | | | 0.5Sn | balance | #3000 | omitted | Colloidal silica (0.02 μm) | 1 | 80 | 90 | B |
| 11 | 1.8 | 0.65 | 1.0 | | | | | | | balance | #3000 | omitted | Aluminum oxide (0.3 μm) | 0 | 60 | 70 | S |
| 12 | 1.8 | 0.65 | 1.0 | | | | | | | balance | #3000 | omitted | Colloidal silica (0.05 μm) | 0.5 | 70 | 80 | A |
| 13 | 1.8 | 0.65 | 1.0 | | | | | | | balance | #3000 | Sulfuric | Colloidal silica (0.02 μm) | 0.8 | 80 | 95 | A |
| | | | | | | | | | | | | acid | | | | | |
| 14 | 1.8 | 0.65 | 1.0 | 0.2 | | | | | | balance | #3000 | omitted | Aluminum oxide (0.3 μm) | 0 | 65 | 75 | S |
| 15 | 1.8 | 0.65 | 1.0 | 0.2 | | | | | | balance | #3000 | omitted | Colloidal silica (0.05 μm) | 0.5 | 75 | 85 | A |
| 16 | 1.8 | 0.65 | 1.0 | 0.2 | | | | | | balance | #3000 | omitted | Colloidal silica (0.02 μm) | 1 | 85 | 95 | B |
| 17 | 1.8 | 0.65 | 1.0 | | | | | | 0.1Mg | balance | #3000 | omitted | Colloidal silica (0.05 μm) | 0.5 | 80 | 85 | A |
| 18 | 1.8 | 0.65 | 1.0 | | | | | | 0.5Sn | balance | #3000 | omitted | Colloidal silica (0.02 μm) | 1 | 90 | 95 | B |
| 19 | 1.8 | 0.65 | 1.0 | 0.2 | | | | | 0.005B | balance | #3000 | omitted | Colloidal silica (0.02 μm) | 1 | 80 | 90 | B |
| 20 | 1.8 | 0.65 | 1.0 | 0.2 | | | | | 0.03Ti + | balance | #3000 | omitted | Colloidal silica (0.02 μm) | 1 | 80 | 90 | B |
| | | | | | | | | | 0.03Fe | | | | | | | | |
| 21 | | | | | 8 | | 0.15 | | | balance | #3000 | omitted | Colloidal silica (0.05 μm) | 0.5 | 65 | 75 | A |
| 22 | | | | | 8 | | 0.15 | | | balance | #3000 | omitted | Colloidal silica (0.02 μm) | 1 | 75 | 85 | B |
| 23 | | | | | | | | 3 | | balance | #3000 | omitted | Colloidal silica (0.05 μm) | 0.5 | 70 | 80 | A |
| 24 | | | | | | | | 3.2 | 0.2Fe | balance | #3000 | omitted | Colloidal silica (0.05 μm) | 0.5 | 65 | 75 | A |
| 25 | 1.6 | 0.4 | | | 0.5 | 0.4 | | | | balance | #3000 | omitted | Colloidal silica (0.05 μm) | 0.5 | 80 | 85 | A |
| 26 | 2.8 | 0.6 | | | 0.5 | 0.4 | | | | balance | #3000 | omitted | Colloidal silica (0.05 μm) | 0.5 | 75 | 85 | A |
| 27 | — | 0.4 | 1.9 | | | | | | | balance | #3000 | omitted | Colloidal silica (0.05 μm) | 0.5 | 70 | 80 | A |
| 28 | 2.5 | 0.56 | | | | | | | | balance | omitted | omitted | omitted | 0 | 0 | 0 | D |
| 29 | 2.5 | 0.56 | | | | | | | | balance | #3000 | omitted | omitted | 80 | 30 | 0 | D |
| 30 | 2.5 | 0.56 | | | | | | | | balance | #3000 | Mixed | omitted | 0 | 40 | 10 | C |
| | | | | | | | | | | | | acid | | | | | |
| 31 | 2.5 | 0.56 | | | | | | | | balance | #3000 | Mixed | Colloidal silica (0.05 μm) | 0 | 0 | 5 | C |
| | | | | | | | | | | | | acid | | | | | |
| 32 | 2.5 | 0.56 | | | | | | | | balance | #3000 | omitted | #3000 | 80 | 30 | 0 | D |
| 33 | 2.5 | 0.56 | — | | | | | | 0.1Mg | balance | omitted | omitted | omitted | 0 | 0 | 0 | D |
| 34 | 2.5 | 0.56 | — | | | | | | 0.1Mg | balance | #3000 | omitted | omitted | 80 | 30 | 0 | D |
| 35 | 1.8 | 0.65 | 1.0 | | | | | | | balance | omitted | omitted | omitted | 0 | 0 | 0 | D |
| 36 | 1.8 | 0.65 | 1.0 | | | | | | | balance | #3000 | omitted | omitted | 80 | 30 | 0 | D |
| 37 | 1.8 | 0.65 | 1.0 | 0.2 | | | | | | balance | omitted | omitted | omitted | 0 | 0 | 0 | D |
| 38 | 1.8 | 0.65 | 1.0 | 0.2 | | | | | | balance | #3000 | omitted | omitted | 80 | 30 | 0 | D |
| 39 | 1.8 | 0.65 | 1.0 | | | | | | 0.1Mg | balance | omitted | omitted | omitted | 0 | 0 | 0 | D |
| 40 | 1.8 | 0.65 | 1.0 | | | | | | 0.1Mg | balance | #3000 | omitted | omitted | 80 | 30 | 0 | D |
| 41 | 1.8 | 0.65 | 1.0 | | | | | | 0.5Sn | balance | omitted | omitted | omitted | 0 | 0 | 0 | D |
| 42 | 1.8 | 0.65 | 1.0 | | | | | | 0.5Sn | balance | #3000 | omitted | omitted | 80 | 30 | 0 | D |
| 43 | | | | | 8 | | 0.15 | | | balance | omitted | omitted | omitted | 0 | 0 | 0 | D |
| 44 | | | | | 8 | | 0.15 | | | balance | #3000 | omitted | omitted | 80 | 30 | 0 | D |
| 45 | | | | | | | | 3 | | balance | omitted | omitted | omitted | 0 | 0 | 0 | D |
| 46 | | | | | | | | 3 | | balance | #3000 | omitted | omitted | 80 | 30 | 0 | D |
| 47 | | | | | | | | 3.2 | 0.2Fe | balance | omitted | omitted | omitted | 0 | 0 | 0 | D |
| 48 | | | | | | | | 3.2 | 0.2Fe | balance | #3000 | omitted | omitted | 80 | 30 | 0 | D |
| 49 | 1.6 | 0.4 | | | 0.5 | 0.4 | | | | balance | omitted | omitted | omitted | 0 | 0 | 0 | D |
| 50 | 1.6 | 0.4 | | | 0.5 | 0.4 | | | | balance | #3000 | omitted | omitted | 80 | 30 | 0 | D |
| 51 | 2.8 | 0.6 | | | 0.5 | 0.4 | | | | balance | omitted | omitted | omitted | 0 | 0 | 0 | D |
| 52 | 2.8 | 0.6 | | | 0.5 | 0.4 | | | | balance | #3000 | omitted | omitted | 80 | 30 | 0 | D |
| 53 | — | 0.4 | 1.9 | | | | | | | balance | omitted | omitted | omitted | 0 | 0 | 0 | D |
| 54 | — | 0.4 | 1.9 | | | | | | | balance | #3000 | omitted | omitted | 80 | 30 | 0 | D |

1. A copper alloy for electronic material, wherein, when its cross section parallel to a rolling direction is observed by SIM, an area ratio of amorphous structure and crystal grains having a grain size of less than 0.1 μm at a depth range of 0.5 μm or less from the surface is 1% or less, and a ratio of the number of crystal grains having a grain size of at least 0.1 μm and less than 0.2 μm to the overall number of crystal grains having a grain size of at least 0.1 μm at a depth range of 0.2-0.5 μm from the surface is 47.5% or more.

2. The copper alloy for electronic material according to claim 1, wherein, when its cross section parallel to a rolling direction is observed by SIM, a ratio of the number of crystal grains having a grain size of at least 0.1 μm and less than 0.2 μm to the overall number of crystal grains having a grain size of at least 0.1 μm at a depth range of less than 0.2 μm from the surface is 57.5% or more.

3. The copper alloy for electronic material according to claim 1 or 2, wherein the copper alloy is phosphor bronze, titanium copper or Corson alloy.

4. A method of manufacture for a copper alloy for electronic material, comprising:
Step 1) polishing a surface of copper alloy base material with an abrasive of count #600-8000 to form a damaged layer having a sufficient thickness such that, when its cross section parallel to a rolling direction is observed by SIM after Step 2), a ratio of the number of crystal grains having a grain size of at least 0.1 μm and less than 0.2 μm to the overall number of crystal grains having a grain size of at least 0.1 μm at a depth range of 0.2-0.5 μm from the surface becomes 47.5% or more, and then Step 2) further polishing with an abrasive having a particle size (d50) of 0.01-0.5 μm to remove amorphous structure and fine crystal grains having a grain size of less than 0.1 μm from the damaged layer such that, when its cross section parallel to a rolling direction is observed by SIM, an area ratio of amorphous structure and crystal grains having a grain size of less than 0.1 μm at a depth range of 0.5 μm or less from the surface is 1% or less, and a ratio of the number of crystal grains having a grain size of at least 0.1 μm and less than 0.2 μm to the overall number of crystal grains having a grain size of at least 0.1 μm at a depth range of 0.2-0.5 μm from the surface is 47.5% or more.

5. The method of manufacture according to claim 4, wherein the abrasive used in Step 1 is made of silicon carbide, and the abrasive used in Step 2 is made of aluminum oxide or colloidal silica.

6. The method of manufacture according to claim 4 or claim 5, wherein the polishing in Step 1 and Step 2 are performed by buffing.

7. A plated product provided with a plating film on a surface of the copper alloy according to any one of claims 1-3.

8. The plated product according to claim 7, wherein the plating film contains any one or more of Ni, Sn and Ag.
